(19) United States
(12) Patent Application Publication
(10) Pub. No.: US 2015/0372959 A1
(43) Pub. Date: Dec. 24, 2015

(54) SOFTWARE INTEGRATED ELECTRONIC MESSAGING CARDS

(71) Applicants: Piragash Velummylum, Seattle, WA (US); Jordan Michael Timmermann, Seattle, WA (US); Jared Allen Russell, Redmond, WA (US); Leelynne Jacob Faris, Seattle, WA (US); Neil Alan Pankey, Seattle, WA (US)

(72) Inventors: Piragash Velummylum, Seattle, WA (US); Jordan Michael Timmermann, Seattle, WA (US); Jared Allen Russell, Redmond, WA (US); Leelynne Jacob Faris, Seattle, WA (US); Neil Alan Pankey, Seattle, WA (US)

(21) Appl. No.: 14/312,587

(22) Filed: Jun. 23, 2014

(51) Int. Cl. H04L 12/58

(52) U.S. Cl. CPC H04L 51/18; H04L 51/08

(57) ABSTRACT

A method and a device are disclosed including software components that are executed on a computing device to enable multimedia communications. A message card constituting an integrated messaging unit is used to transmit and receive multimedia data between two or more computing devices. The card may contain text, picture, animation, sound, video, metadata, and other messaging data and information, some of which may be encapsulated in software stickers embedded in the message card. The cards may be stacked, stored, searched for, modified, augmented with stickers, and the like. The stickers may have various looks and functions including providing a message, animation, video, picture, hologram, be peeled off, be scratched to reveal content, detect movement of the computing device, detect finger tapping, show emotions, provide quick reply to messages, and the like. The looks, contents, and behaviors of the message cards and/or the stickers may be programmable by the user.

### CROSS-REFERENCE(S) TO RELATED APPLICATION(S)

The present application is a Continuation-In-Part (CIP) of, and claims the benefit of the filing date of U.S. application Ser. No. 14/106,516, filed on 13 Dec. 2013, entitled “ STICKERS FOR ELECTRONIC MESSAGING CARDS,” the contents of which are hereby expressly incorporated by reference in their entirety, under 35 U.S.C. §120.

### TECHNICAL FIELD

This application relates generally to electronic messaging. More specifically, this application relates to software integrated messaging units or cards usable with software stickers.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3A shows an example computing device on which a messaging application runs;

FIG. 3B shows an example a smartphone or other mobile computing device on which a messaging application runs;

FIG. 4A shows an example set of message cards suitable for multimedia communications;

FIG. 4B shows an example sequence of message card communications;

FIG. 5A shows an example software sticker usable with message cards of FIGS. 4A and 4B;

FIG. 5B shows an example software sticker with an integrated sound file;

FIG. 5C shows an example animation sequence using software stickers;

FIG. 5D shows an example message card construction using various text and multimedia elements including a picture software sticker;

FIG. 5E shows an example holographic software sticker deployed onto a message card;

FIG. 6A shows an example smart mobile computing device which activates a software sticker by shaking the computing device;

FIG. 6B shows an example smart mobile computing device which activates a software sticker by rotating the computing device;

FIG. 7 shows an example message card with multiple software stickers which can be scratched to reveal the sticker contents and which can be peeled off from the message card;

FIG. 8A shows an example message card having a mix of regular and power stickers deployed thereon;

FIG. 8B shows an example message card with multiple power stickers;

FIG. 9A shows an example communication session between a sender and a receiver using message cards and power stickers;

FIG. 9B shows the example communication session of FIG. 9A where the power sticker activates a different software application;

FIG. 10 shows an example computing device on which software stickers with text and graphics contents may be created; and

FIG. 11 shows an example computing device on which software stickers with pictorial and video contents may be created.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular computing devices such as smartphones, it will be appreciated that the disclosure may be used with other types of computing device such as tablet, laptop, desktop, smartwatches, connected TVs, gaming consoles, connected glasses, phablets (phone-tablets), and the like.

Briefly described, a device and a method are disclosed including software components that are executed on a computing device to enable multimedia communications. In various embodiments, a message card constituting an integrated messaging unit is used to transmit and receive multimedia data between two or more computing devices. Acting as a software information container, the message card may contain text, picture, animation, sound, video, metadata, and other messaging data and information. Some of the information may be encapsulated in software stickers, which are software components that may be embedded in the message card by a user of the communication system such as a sender or a receiver. The messaged cards are data records that may be manipulated as objects. The manipulation may include stacking the cards as an ordered set like a stack of playing cards, sequencing them, filtering them based on various contents or metadata, storing them, searching for them, modifying them, attaching and detaching stickers from them, combining them in a sequence to form a thread of information or conversation, creating a card library, and the like. In various embodiments, the stickers may provide various looks, behaviors, and functions including providing a message, animation, video, picture, hologram, be peeled off, be scratched to reveal content, detect movement of the computing device on which they are running to reveal their contents or behaviors, detecting other input such as finger tapping from a receiving user to behave in a predetermined manner, be used to show emotions, be used to quickly reply to other stickers or message cards, be used as tokens, and the like. In various embodiments, the looks, contents, and behaviors of the message cards and/or the stickers may be programmable by the user.

With the ubiquity of users' access to the Internet and/or communications airways, there is an ever increasing demand for expanded services, functionality, online storage, sharing capabilities, and the like. One of the most visible and popular of these services is personal messaging using various techniques and such as SMS, OTT (Over-The-Top), MMS (Multimedia Messaging Service), texting, and the like. These technologies offer quick, reliable, effective, personal, and private communications to individuals and businesses at affordable costs. As of 2013, the world wide size of the mobile messaging market is estimated at about $230 Billion. This market is poised to expand with further availability and lower cost of smartphones and mobile advertising.

However, the currently available messaging systems also tend to be unexciting and bland, limited in contents to text and some multimedia content such as pictures and video clips. A more exciting and customizable messaging system with added and personalized functionality, conducive to gaming and amusing personal communications is needed, especially for younger people such as teenagers.

### Illustrative Operating Environment

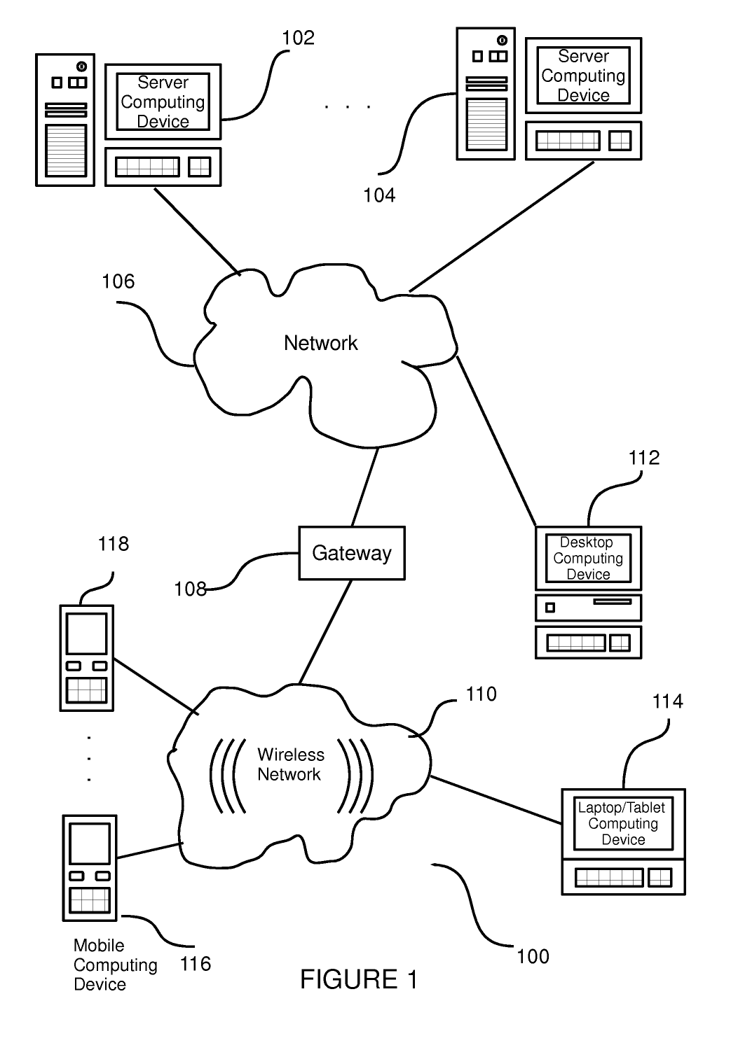

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

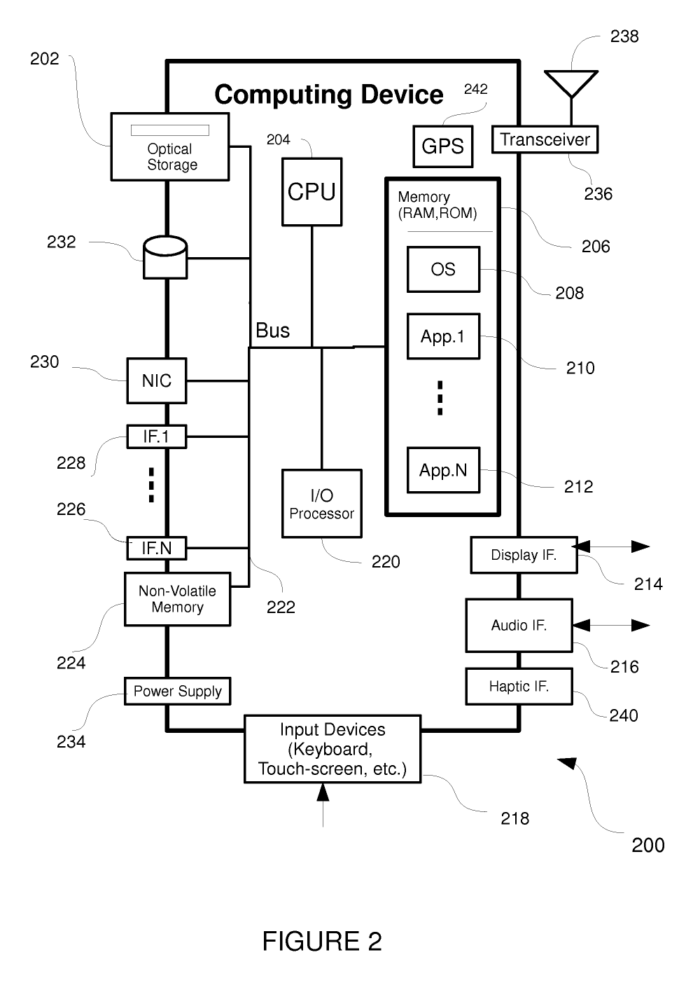

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), JavaScript Object Notation (JSON), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, Extensible Messaging and Presence Protocol (XMPP), or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ HDML, WML, WMLScript, JavaScript, SMGL, HTML, XML, JSON, and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

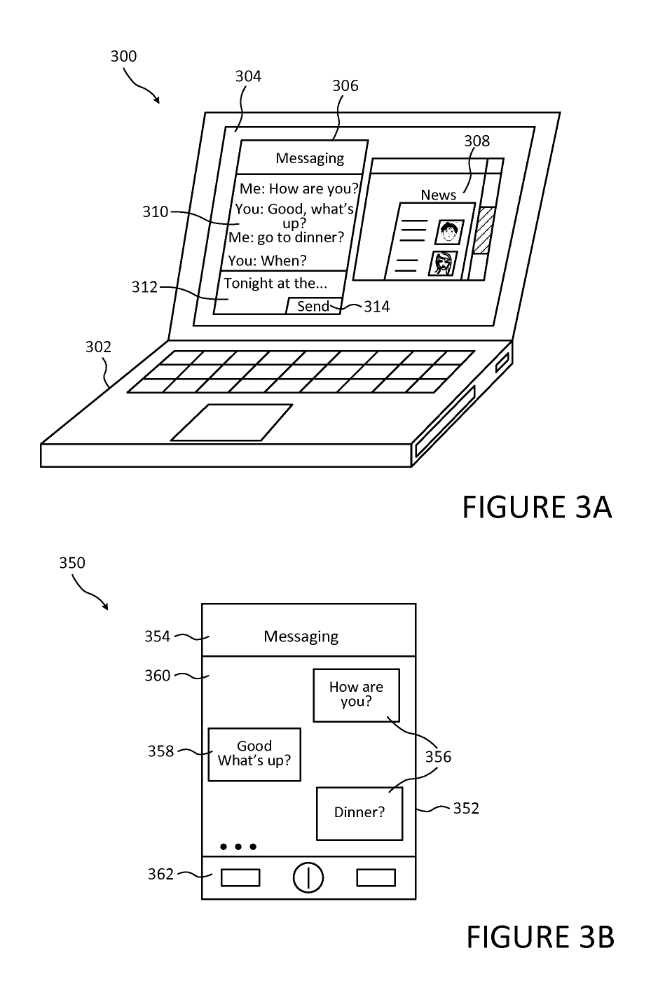

FIG. 3A shows an example computing device on which a messaging application runs. In various embodiments, messaging session 300 may include computing device 302 having screen 304 displays messaging application 306 with conversation reading area 310 and writing area 312. Send button 314 transmits the written conversation to the receiving party and also includes the sent text in the reading area 310. Other web pages 308 or software applications may also be displayed on the computer screen 304.

In various embodiments, the computing device 302 may be one of the devices shown in FIGS. 1 and 2. In various embodiments, messaging application 306 runs on the sending computer and the receiving computer. The messaging application running on the transmitting and the receiving computing devices may be the same or different application. In either case, the messaging applications on the transmitting and the receiving ends communicate using the same or compatible communication and data transmission protocols, such as HTTP, RTMP (Real Time Messaging Protocol), SOAP (Simple Object Access Protocol), WSA (Web Services Addressing), and the like utilized at various levels of the communication stack and phases.

FIG. 3B shows an example a smartphone or other mobile computing device on which a messaging application runs. In various embodiments, a messaging session 350 includes a smartphone 352, or other suitable computing device, having a messaging application 354 running thereon, with a communication display area 360 displaying a thread of conversation with data sent 356 by a first party and data sent 358 by a second party, visually separated and distinguished. In various embodiments, hardware buttons 362 may be included on smartphone 352.

In various embodiments, typically, the messaging applications run in the background on a computing device and listening for incoming messages. Once an incoming message indication is received, the messaging application comes to the foreground on the computing device and notifies the user of the incoming message. Those skilled in the arts appreciate that the user of a computing device may be notified in variety of ways, such as by sound, vibration, light, and the like. The user may also be notified by operating system's notification/alert facilities working on behalf of various application software, such as the messaging application. The receiving user then has an option to respond, delete, ignore, leave the message for a later response, or other action as necessary. Various messaging applications handle the conversation between two or more parties in various ways. Some may use different colors to distinctly display the text or data originating from each of the parties of the conversation. Others, may divide the screen and display the data from one party on the left side (or bottom) of the screen, and the data from the other party on the right side (or top) of the screen. In some embodiments, cards may be labeled by the sender's ID and may be aggregated in threads of conversation shown as stacks of cards from each party. This way, it is easy to distinguish where each comment or data originated.

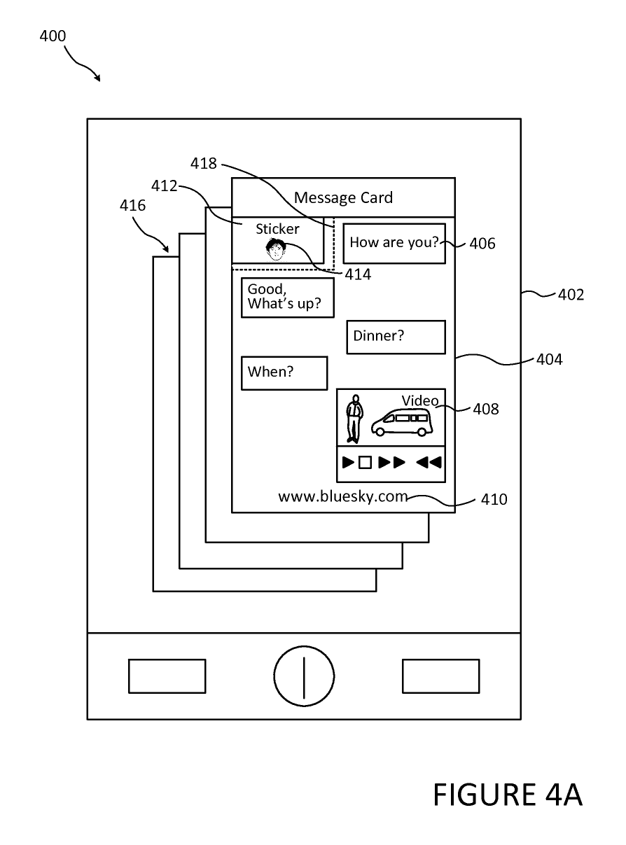

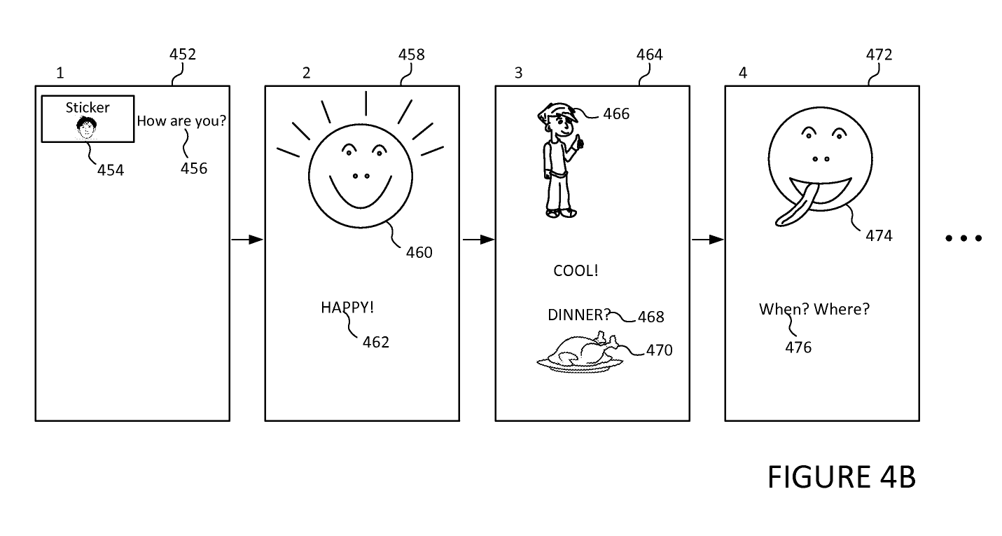

FIG. 4A shows an example set of message cards suitable for multimedia communications. In various embodiments, communication session 400 is carried out using a computing device 402 using message cards 404 to communicate between two or more parties to a conversation. The message cards may include text data 406, pictorial and video data 408, hotlinks 410, and software stickers 412 with graphics or animation data 414. The message cards 404 may be stacked as a deck of message cards 416 to represent a conversation session and all the information passed back and forth between the parties.

In various embodiments, the message card 404 is a messaging unit or a software object having data and/or executable code that may be used to convey various information in different formats such as text, pictures, images, sound, graphics, animation, video, hotlinks, executable code segments such as Objective-C controls/code, JavaScript, Java Applets, and Microsoft ActiveX Controls, metadata, and the like. In various embodiments, a message card may be used once as a single-use messaging unit by one party to the communication, while in other embodiments the message card may be reusable with or without editing The sending party may include any number of several types of data on the message card and transmit the card to the receiving party. The receiving party may then generate another message card in response to the received card and include other various information on his own card. Thus, each message card serves once as a carrier of information from a single party. The message cards accumulate as new cards are created and/or used in a conversational exchange between two or more parties. The set of cards so accumulated constitute a conversation thread. In various embodiments, cards may be linked or otherwise associated with each other to form a stack of cards which may be save, searched, filtered, forwarded, reused, deleted, or be manipulated in other useful manners.

In other various embodiments, the message cards may be used multiple times in a conversation, similar to using a token. For example, the message card may be used by a first party to send some data or message to a second party. The second party may take the same card and modify the existing data or add his own data to the card and send it back to the first party. This way, a single message card may represent a thread of conversation including several replies and related data back and forth between the parties.

In various embodiments, the message cards may be used only once to transmit a single message and once it is used, it gets locked and cannot be edited, as shown and described with respect to FIG. 4B below. As such, a message card may be used as a single part of a conversation. It can also be recombined with other cards to repeat a conversation, or part of a conversation, with another party. The message card stack may also be used as archival repository for various information, such as contact information of various parties, hotlinks to other information, video clips, pictures, metadata, and the like.

In various embodiments, a message card has object-like or token-like behavior, which allows the user to handle or treat message cards like physical cards in some respects. The message cards may be freely moved around in a card deck, they may be combined and recombined into a smaller or different card stack to form a different conversation or thread, they may be stored and retrieved, they may or may not be duplicated based on permissions or card type, and the like. The message cards may also be treated as a unique object or token that cannot be duplicated. Thus, if a card is sent to a recipient, the sender may no longer be in possession of the card. In some embodiments, the message cards may be self-contained software apps that need no external host application to execute for reading or writing, while in other embodiments, a separate host application may be needed to open and read the cards or otherwise handle them. As self-contained apps, the message cards may be freely sent to any computing device that can execute the app type, independently of other software components and environments, because the message card can be executed as a standalone application for reading writing, replying, and other message card operations. In various embodiments, the message card may be processed by its own embedded software, a host software on the computing device containing the message card, processing software on a remote computing device such as on a web server, or a combination of the above.

In various embodiments, multiple message cards may be associated together to form a collection or stack of message cards. The message card stack may be viewed as a set of ordered message cards linked or otherwise associated together, for example, via a table, a database row, a group identifier, metadata in a message card header, etc. The message card stack may be filtered according to various criteria. The filtering criteria or parameters may include sender, receiver, date range, timestamp, subject, contents, content type, size, communication thread, metadata, attachments, stickers, and the like. In various embodiments, more than one filtering parameter may be used simultaneously to filter the message cards. For example, a user may select only a subset of message cards on his device, such as a smartphone, for display according to the sender of the message cards and/or a date range used as filter parameters.

In some embodiments, the filtering operation on message cards may be initiated by tapping on a filtering parameter on the touchscreen. For example, if the user wants to select message cards from a particular sender, a particular subject, or a particular date, he can tap on the respective field of a stack of cards on his computing device to separate the filtered cards from the stack and only display those cards so selected. Those skilled in the art will appreciate that other techniques for selecting/filtering cards may be used without departing from the spirit of the present disclosures. For example, a user may swipe a stack of cards in a particular way, such as from bottom up or from left to right, to select a predefined filtering parameter on a card being swiped and filter the cards based on the value of that parameter. For instance, swiping from bottom up on a particular card in the stack may be associated with selecting the sender on the particular card as the filtering value, while swiping from left to right may be associated with the date range on the particular card.

In various embodiments, message cards may be generated manually by the user or automatically by the message card communication system. The types of the card generated may be dependent on the content type the user desires to use. For example, if the user indicates that he wants to include a video clip on the message card, then a “video” card may be generated for his use. Similarly, if a user wants to only include text on the card, then a “text” card may be generated.

The difference between cards having different contents may include the embedded properties and software that is included with the software implementation of the card. For example, a video message card may include a simple video playback software component that allows independent playing of the video content even if a receiving computing device lacks such playback software. A text message card may be very small and efficient and not have any extra software components that are not used, such as a video playback component. Similarly, each message card may be different and have a different configuration and makeup based on the intended content type. In some embodiments, predefined templates may exist for each content type to make generation of different card types more efficient and faster. For example, message card templates may include templates for text, video, web links, applications, and the like.

In various embodiments, the contents of a message card may be obtained directly via techniques other than a keyboard or touch screen. Visual contents, such as photographs and videos may be obtained from a camera and directly saved within a message card as content, as opposed to attachments. For example, a user may take a picture of himself and save it directly onto a message card. In some embodiments, the message card may include multiple layers of contents such as a background and a foreground. The background may be a picture directly pasted onto the card, while the foreground may be text entered via a keyboard (soft or hard), or a hand written via a touch screen like writing with a pen. In some embodiments, more than two layers may be embedded within a message card. For example, a repeating video background or picture background showing a landscape may be used as a deep background, a picture of person may be used as mid-level background, and a text may be used as foreground.

In various embodiments, the user may selectively blur or hide one or more of the layers. For example, the user may tap or swipe in a particular way to blur the background picture while keeping the text clear. Similarly, the text may be blurred or hidden by a particular hand gesture or action while the background picture remains visible and in focus. This way the user can shift the focus on the information he wishes.

In various embodiments, the software sticker 412 may be software components, messaging units, or software object having data and/or code, which may be selected from a set of stickers and associated with one or more message cards. In some embodiments, the association of software stickers with message cards resemble the application of a physical sticker to a sheet of paper and mimic the behavior in other ways. For example, a user may select or more software stickers from a set of predefined stickers, apply the sticker to the message card and send the message to the receiver. The sticker may have many shapes, forms, behaviors, and uses.

The shape of the sticker may be round, rectangular, polygonal, triangular, other geometric shapes, or irregular. In various embodiments, the sticker and its visually represented data, including text and images, occupy a portion of a display area of the message card. This way, when the message card is opened by the receiving user, the user can see the software sticker, in contrast to email attachments, which are first opened and then are visually dis-associated and disconnected with the body of the email. Additionally, in various embodiments, the user interacts with the message card and its associated software sticker affixed to the card, in one integrated manner and one computing environment. That is, the stickers may not need a software application, separate from the application used to read the card, to be read or manipulated.

The form and contents of the software sticker may range from static text to executable code. It may further include pictures, animation, graphics, video clips, hotlinks to other content in the same or another application, metadata, and other types of information. The executable code may be embedded in a sticker or be referenced by a sticker to perform a predetermined function or cause the sticker to behave in a predetermined fashion. An executable code associated with the software sticker may look for a particular user input to perform its designated function. For example, a scratching motion with a fingernail or fingertip on the sticker may cause the code associated with sticker to gradually reveal data on the sticker akin to a paper sticker being scratched away to reveal what is written on the underneath, as seen in some games of chance such as some paper lottery tickets.

The software stickers may be used for many purposes and in various forms including gaming, emotions, holograms, hotlinks/pointers, input-sensitive, various themes, upgradable, sequenced or animated, peelable, token-based, haptic, gift, location-based, filterable, and the like. Some stickers are power type stickers which are active or have a broad scope with multiple behaviors or actions. Power stickers include location-stickers, shake stickers, reveal, shield, “contact me,” “call me,” “reply,” graffiti, cross-post, walkie-talkie, geo-hashing, challenge, bounty, vampire, “one-up,” props, fog, bomb, narcissist, timer, hot potato, and any other behaviors or properties that can be implemented using a dynamic software container such as a sticker. These sticker types and behaviors will be described later on with respect to other figures.

In various embodiments, stickers may be predefined or defined and/or created by the user as needed. For example, a blank sticker may be created and then filled with pictures, text, video clips, music, color, active/executable code, and the like. Predefined stickers may be purchased, downloaded, or otherwise acquired locally or from a remote third-party based on location, gender, subject, size, cost, features, or any other characteristic, which can be used to group or categorize stickers.

In various embodiments, the message card based and/or software sticker based communication system may be implemented by a hardware and/or software system using one or more software components executing on the illustrative computing device of FIG. 2. One or more functions may be performed by each software module recorded on a medium such as an optical disk, magnetic tape, volatile or non-volatile computer memory, and the like, or transmitted by various communication techniques using various network and/or communication protocols, as described above with respect to FIG. 1. For example one or more separate software modules or components may be used for processing activities related to message cards and each of the associated functions for selecting a message card, searching for a card, filtering a card, stacking cards, storing cards, rearranging cards, sending cards, receiving cards, forwarding cards, deleting cards, editing cards, and the like.

Similarly, one or more software modules may be used for handling activities related to software stickers and each of the associated functions pertaining to software stickers may be performed by one or more software modules. For example, a software search module may be used to search for a card and/or a sticker based on various parameters such as the sender or creator of the card or sticker. Those skilled in the art will appreciate that one function may implemented using multiple software modules or several functions may be implemented using one software module. With further reference to FIG. 2, these software modules are generally loaded into the memory module 206 of the computing device for execution.

FIG. 4B shows an example sequence of message card communications. In various embodiments, the communication session includes a successive of multiple message cards 452, 458, 464 and 472 by a sender and a receiver. An initial card 452 sent by the sender may include a sticker 454 for quick communication of a greeting 456, replied to by a card 458 from the receiver including a sticker 460 and text message 462. The sender may again respond with card 464 having stickers 466 and 470. The receiver may again respond with card 472 having sticker 474 and text 476. And so on, creating a communication session.

In various embodiments, in a communication session, each card may represent a single unit of communication from one party to another. In this embodiment, a single card is only used once by its sender and is not used for another message or a reply. In some embodiments, As noted before, the cards and/or the stickers may be used only once, a limited number of times, or as many times as needed, depending on system implementation and/or setup, user preferences, user profile, security policy, and the like. In some embodiments, an issued card may be used multiple times but only by a particular user, such as its original sender. It may also be used a limited number of times as indicated by an integral counter on the card or sticker. Those skilled in the art will appreciate that other conditions may be imposed on the reuse of the card and/or the stickers. For example, a card may be reused by all except by the original sender, or by other users on an access list, and the like.

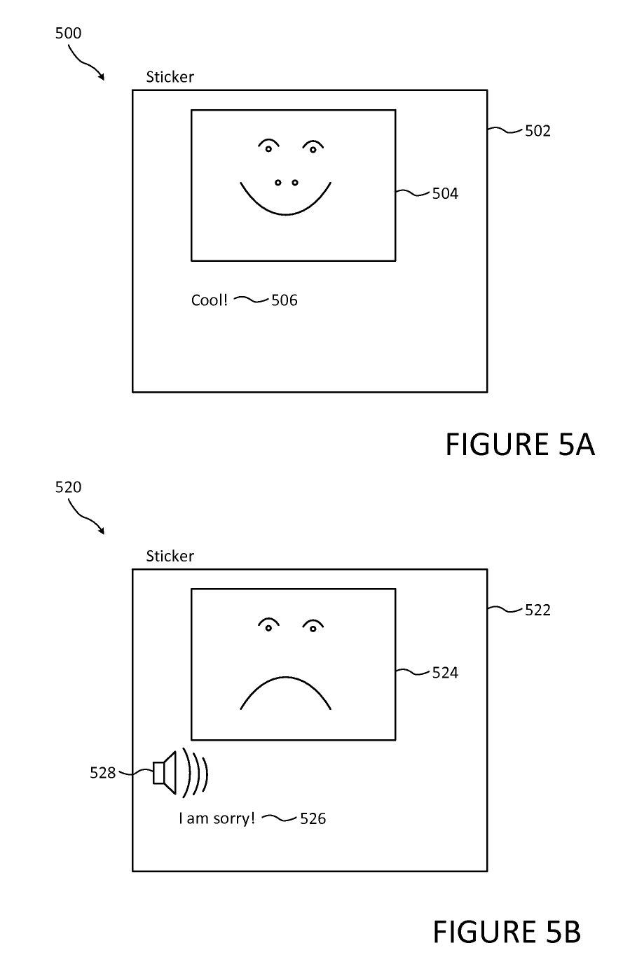

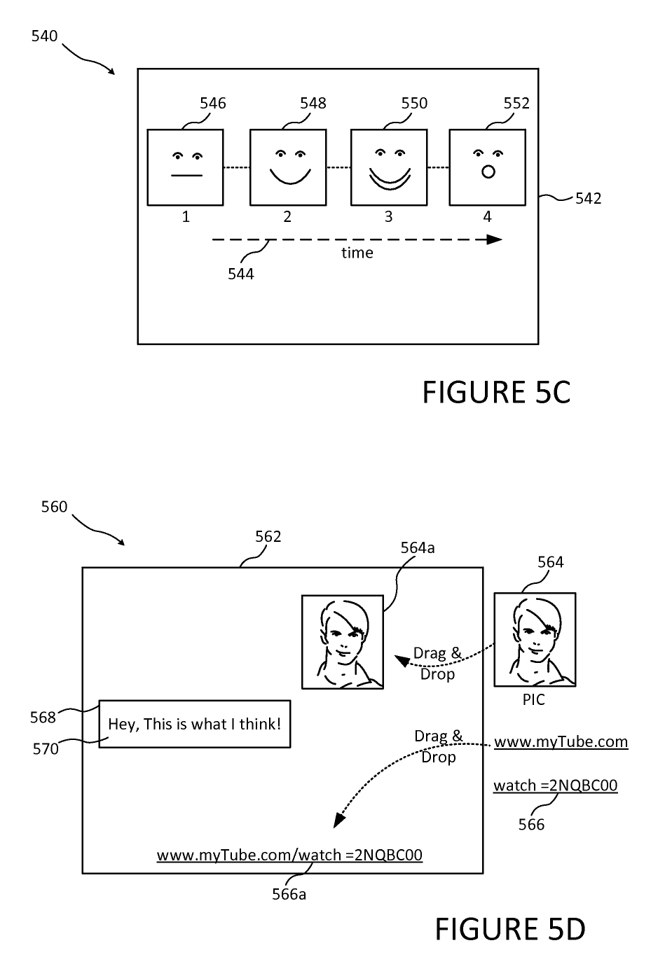

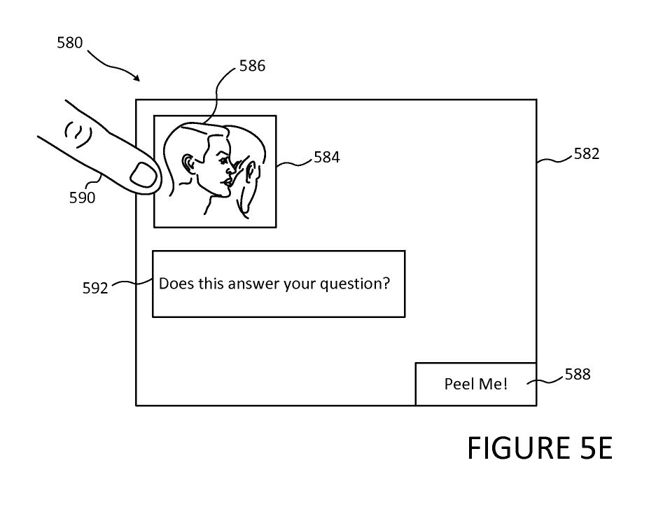

FIG. 5A shows an example software sticker usable with message cards of FIGS. 4A and 4B. In various embodiment, software sticker 500 may include sticker writable area 502, picture 504, and text 506.

In various embodiments, stickers may be used to provide a quick reply to a received message card with a rich selection of information included in the response. For example, if a friend sends a message card and announces the purchase of a new car, the receiver can quickly take a picture from himself with a surprised or happy expression using his smartphone, include his picture on a new sticker, electronically affix the sticker to a reply message card and send the reply message card back to his friend. In some embodiments, a new message card may include a copy of some or all content of the previous message card to allow continuity of communication. Some or all of the contents of one or more previously transmitted cards may be copied by the user to the new card. For example, only the text portion of a card may be copied instead of all contents such as pictures, stickers, and the like, to save space on the card and increase transmission performance. In various embodiments, stickers may be reusable and also may be use-limited. A sticker may be only allowed to be used once, like a physical mailing stamp, or under some conditions or in some embodiments, a sticker may be reused. For example, the sticker may be allowed to be used a limited or an unlimited number of times by the same sender, a receiver may be permitted to reuse all or part of the sticker once or a limited number of times, and other similar rules.

In various embodiments, continuity of communication may be preserved by data embedded in the cards sent back and forth between two or more parties. For example, if a message card has an ID, such as a GUID (Globally Unique ID), the GUID from an immediately previous card may be saved on the next card to chain the sequence of cards by linking them together in this way. The cards and/or the stickers may also include a timestamp either as part of the GUID or separately to be used for time-sorting, filtering, and searching of cards. The chain may be uni-directional or bi-directional. In the uni-directional chain, each card only contains the ID of the previous card, while in a bi-directional chain, each card may be modified to include the ID of the next card once it is issued. Software pointers or references may also be used to point to other software objects such as message cards and software stickers, for example, using web services and SOAP envelopes. A conversation is thus a sequence of message cards. Different conversations may be synthesized by changing the chain links between the message cards, which changes the sequence of the cards.

FIG. 5B shows an example software sticker with an integrated sound file. In various embodiments, software sticker 520 may include sticker writable area 522, picture 524, text 206, and sound file 528.

In various embodiments, a sound clip or other multimedia content such as a video clip may be included on the software sticker to enhance the communication experience. Picture 524 may be an emoticon or other graphical expression, a picture, or other image relevant to the communication. Similarly, the sound and video file may be used to express appropriate sentiment, share something funny, encourage, complain, express surprise, or any other expression, emotion or information as needed.

In various embodiments, the sound clip, the video clip, or other multimedia content may be activated to play automatically by opening the message card on which the software sticker is affixed. Such multimedia clips may also be activated by other techniques, such as tapping with a finger on the sticker, the context in which the sticker or card is opened, by sensed movement of the computing device such as a detected shaking of it, by identity of the recipient, by time delay, or any other external input, event, or environment. For example, if a software sticker has a happy birthday song or video clip and is sent to a recipient, the clip may start automatically playing when the receiver's birthday arrives. An alarm event with the exact time and date of birthday may be programmed into the sticker to play it when the alarm goes off. Those skilled in the art will appreciate it that any other set of conditions or combinations of events and conditions may be used to activate a predefined action embedded in a sticker, using executable code such as Objective-C controls/code, Javascript, ActiveX Control, or Java Applet.

In other embodiments, the sticker may not contain all of the executable code necessary to carry out an action. Rather, the sticker may include references or pointers to other locations containing the code. Such locations may be local to the receiving computing device, the Internet, a remote server, and the like. Continuing with the birthday example, the sticker may include a link to open a predetermined web page which plays a personalized happy birthday video clip for the receiver. Similarly, the software sticker may include a reference to invoke a web service to perform a predefined action. The sticker may also launch a local application, such as a word processor, an email application, or other software application on the receiving computer or smartphone when the receiving party opens the message card for viewing.

FIG. 5C shows an example animation sequence using software stickers. In various embodiments, animation sequence 540 includes message card 542 over time 544 revealing a sequence of stickers 546-552, in order one after another, in the same location on the message card.

In various embodiments, multiple software stickers may be affixed to a message card which are then gradually displayed over time in succession by the message card to provide the illusion of animation. For example, the “smiley face” stickers 546-548 show successively bigger smiles which when displayed in succession create the illusion of an animated smile to laughter using multiple static images.

FIG. 5D shows an example message card construction using various text and multimedia elements including a picture software sticker. In various embodiments, message card construction 560 includes loading a message card 562 with pictures or videos 564 and 564a, text box 568 with text 570, references or hotlinks 566 and 566a, among other information components.

In various embodiments, a message card may be created by the user using a special software module for message card creation and editing, while in other embodiments, various types of message cards may be automatically generated by the card-based communication software application or system. The cards may vary in terms of size of contents, format, type of contents allowed, functional capabilities, and the like. For example, a card may range from a simple text container to a full function multimedia message card having the capabilities to include active or executable code, different programmed behaviors such as delayed display and sequential animation, and the like. In some embodiments, the programmed behaviors may be embedded in the message card, while in other embodiments, the behavior may be included in the software sticker affixed to the card. In still other embodiments, the programmed behaviors may be included in both the card and the sticker. Some of the programmed behaviors of the message card and/or the software sticker are described below at least with respect to FIGS. 5-9.

In various embodiments, once a card is created in a card editor software module, various text, graphical, and multimedia content can be added to the card prior to transmission. On some devices, such as tablet computing devices, such content may be dragged and dropped into the card, while on other devices such as smartphones and phablets (large screen smartphones) cut and paste operations, clipboard copying, or other techniques may be used to transfer various types of data and contents onto a card. For example, a sticker with a picture of the sender 564 may be dragged and dropped onto the message card as a picture 564, new text may be typed in, and a hotlink web address may be dragged in.

FIG. 5E shows an example holographic software sticker deployed onto a message card. In various embodiments, message card 580 includes display area 582, sticker 584 having holographic image 586 activated by finger tip 590, text box 592, and another peel-able software sticker 588.

In various embodiments, the software sticker 584 may have a holographic image embedded or programmed into it to show 3-D effects, rotation, zoom in and out, and other image manipulations. The holographic effects may be activated by the motion of the smartphone as detected by the accelerometer. The effects may also be activated by external input such as touch, tapping, or other user input such as a voice command, or may be displayed automatically when the message card is opened.

In various embodiments, software sticker 588 may behave like a token. A token is a unique entity, which may be only accessed or controlled by a single entity at a given time. In this respect, a token is similar to a physical object that if one person or entity has it, another person cannot. That is, its possession or access to it is mutually exclusive with respect to multiple parties. Some software stickers may have this token property based on their GUID. When a token sticker is sent to a receiver, the receiver can mimic the motion of peeling off the sticker, as if it were a paper sticker on a surface, and then reapply the same sticker to another message card to the sender or to another receiver. The capability to peel off a token sticker may be controlled according to various criteria such as the receiver, the sender, time of day, history of previous usage of stickers, and any other set of conditions or events. For example, a token sticker may include a shopping discount code/coupon that once used it cannot be redeemed further. Such a discount code sticker may be sent to a friend as a gift. The friend may wish to peel it off and give it to another friend as a gift. However, if first friend has already redeemed the discount coupon, then the sticker may no longer peel off. Similarly, the sticker may be a birthday gift that the user cannot peel off before the time of birthday is reached.

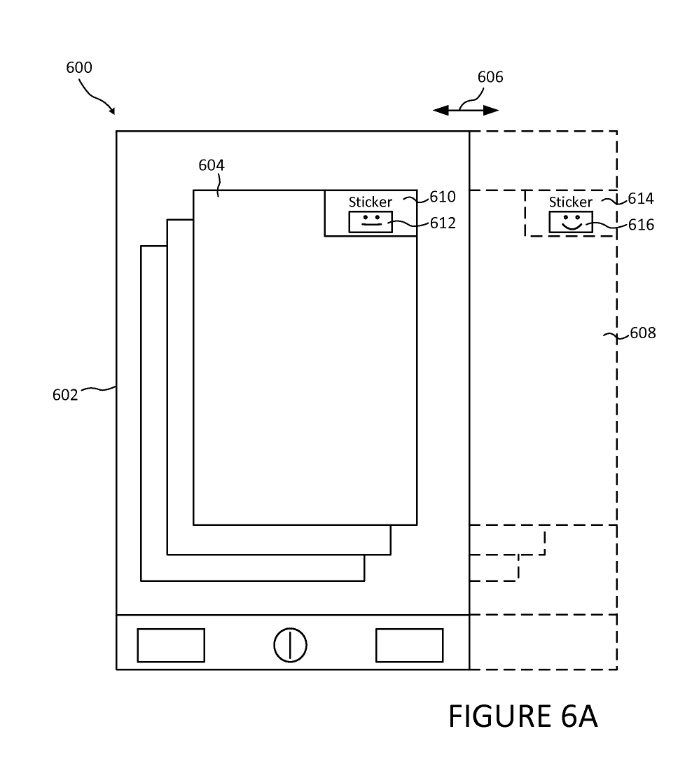

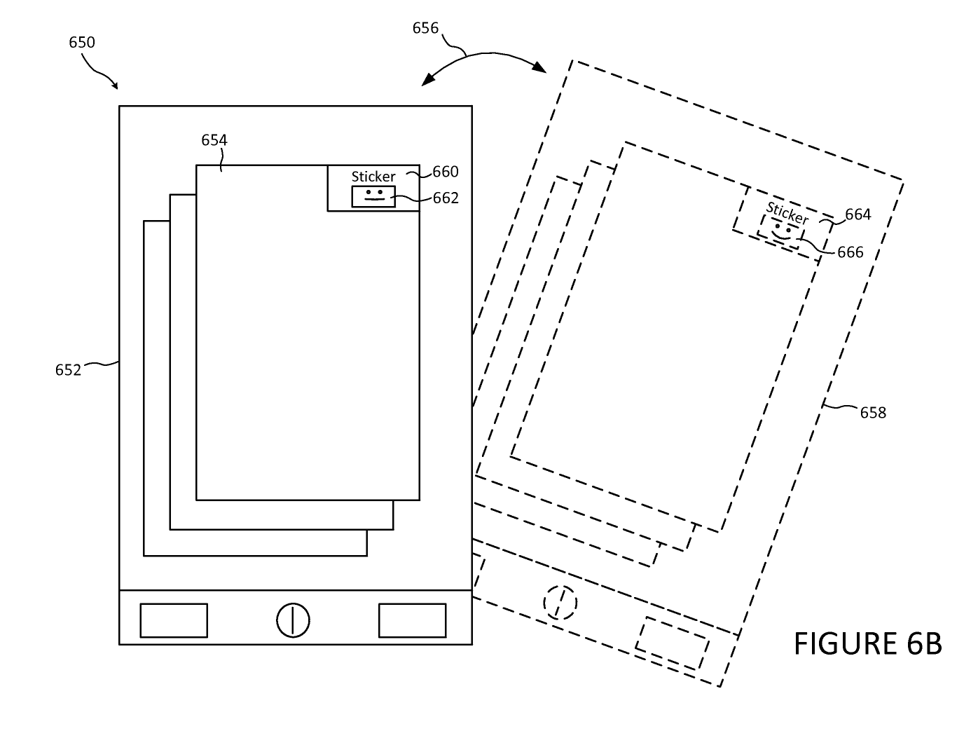

FIG. 6A shows an example smart mobile computing device, which activates a software sticker by shaking the computing device. In various embodiments, the shaking arrangement of 600 of smart mobile computing device 602 includes one or more message cards 604, each having one or more software stickers 610 with content 612. As the computing device 602 is quickly, with a shaking motion, moved to position 608 and back as depicted by arrow 606, software sticker 610 transforms to a new sticker form 614 with content 616 which is different from content 612.

In various embodiments, the shaking motion of the computing device, such as a smartphone, may be sensed by a device within the smartphone, such as an accelerometer. Once the shaking motion is thus sensed, a signal may be sent to an executable code, or otherwise an executable software module is caused to be executed to change or modify the content of the sticker. In various embodiments, the executable software may be embedded in the sticker, in the message card, in the card-based communication system, or in a combination thereof.

Those skilled in the art will appreciate that the executable code thus launched may effect any changes in the sticker or cause other actions to be taken by the sticker and/or by other software applications. For example, the shaking of the smartphone may cause a hidden image to appear on the sticker, a sound clip to be played, or another software application related to the content of the sticker be launched.

In various embodiments, a sticker may be enabled to show its content or behave in a particular and preprogrammed manner by acquiring information from a physical source external to the computing device on which the sticker is viewed. For example, a user may enable a sticker on his smartphone by scanning a physical version of the sticker in a particular location. Such external enablement of software stickers may allow playing games like geo caching, enable marketing various products and services, and generally control the sticker experience externally. For example, in geo caching games, when an external object, barcode, or marker is found and scanned, a corresponding sticker is enabled to show the next clue. Similarly, when a user visits a store and scans a physical sticker, then his electronic or software sticker is enabled to show a discount coupon useable at that store. Those skilled in the art will appreciate that many processes and games may be controlled externally in similar ways without departing from the spirit of the present disclosure.

FIG. 6B shows an example smart mobile computing device which activates a software sticker by rotating the computing device. In various embodiments, the shaking arrangement of 650 of smart mobile computing device 652 includes one or more message cards 654, each having one or more software stickers 660 with content 662. As the computing device 602 is quickly, with a rotating or angular motion, moved to position 658 and back as depicted by curved arrow 656, software sticker 660 transforms to a new sticker form 664 with content 666, which is different from content 662. This arrangement is similar to the shaking arrangement of FIG. 6A, described above.

In various embodiments, the rotational motion of the computing device, such as a smartphone, may be sensed by a device within the smartphone, such as an accelerometer. Once the rotational motion is thus sensed, a signal may be sent to an executable code, or otherwise an executable software module is caused to be executed to change or modify the content of the sticker. In various embodiments, the executable software may be embedded in the sticker, in the message card, in the card-based communication system, or in a combination thereof.

Those skilled in the art will appreciate that the executable code thus launched may effect any changes in the sticker or cause other actions to be taken by the sticker and/or by other software applications. For example, the shaking of the smartphone may cause the a hidden image to appear on the sticker, a sound clip to be played, or another software application related to the content of the sticker be launched.

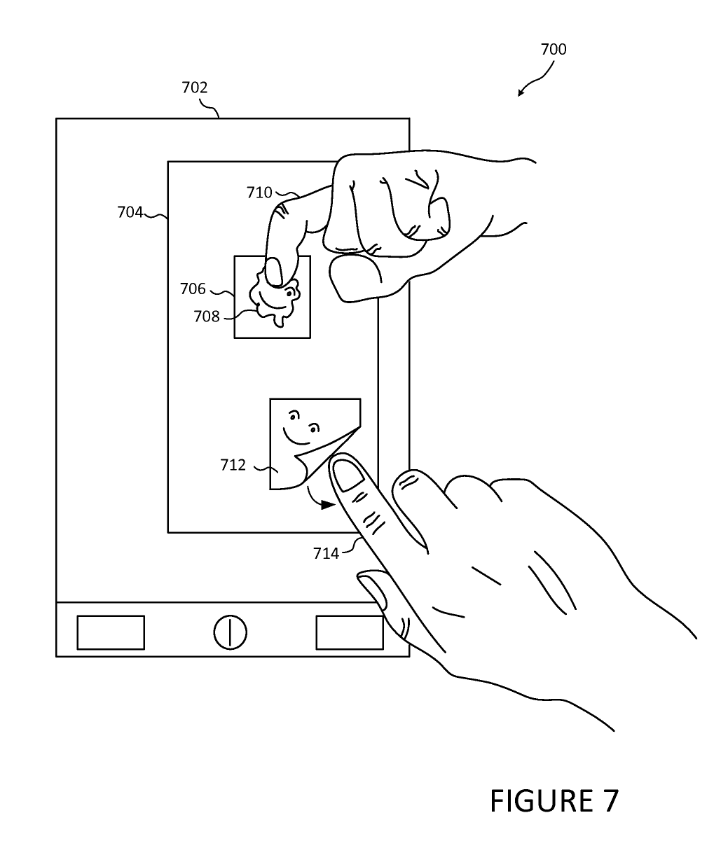

FIG. 7 shows an example message card with multiple software stickers which can be scratched to reveal the sticker contents and which can be peeled off from the message card. In various embodiments, communication arrangement 700 includes a communication device 702, such as a smartphone, having a software sticker 706 with content 708, which can be activated by a scratching motion of hand 710, another software sticker 712, which can be activated or removed by a peeling motion of hand 714.

In various embodiments, the software sticker may behave in particular ways in response to a user input. The input may include a finger tap, a touch, a swipe, a pinch, a shake or rotation of the smartphone device, a press of a software or hardware button, a voice command, or any other type of external user input suitable for a mobile device.

In various embodiments, the resulting behavior of the software sticker may take one or more of a number of forms. It may reveal content such as an image, cover or fade content, start a clock or timer running, stop a running clock, run an executable code embedded in the sticker, cause another external executable code to run, play a sound or video clip, play an animation clip, change color, reveal or transmit data, mutate or change the card to which it is affixed or manifest any other behavior possible by a software object. In various embodiments, a software sticker may exhibit more than one type of behavior or reveal more than one type of property/characteristic in response to different inputs or conditions. For example, a sticker may be both scratchable, in response to a scratching motion, and peelable, in response to a peeling motion. A sticker may also behave in multiple ways in response to one input, or respond in one way to multiple types of inputs.

Revealing content in response to a scratching motion and being peeled off (disappearing from display) in response to a peeling off motion are two examples of such sticker behavior. The scratching motion can trigger a behavior of revealing what's apparently hidden under the sticker, such as an image, text, or code. In various embodiments, the scratchable sticker may have multiple and/or updated hidden content and may thus be reusable. For example, once the user scratches the sticker, a picture or a text phrase may be uncovered. After a predetermined amount of time the sticker may be covered over again and be ready for another scratch-off. The next scratch-off may reveal the same content or a different updated content.

A peeling motion may invoke a behavior in a sticker of being peeled off. The sticker is removed from the message card and will no longer be visible or useable on its original host card. In various embodiments, such peeled off sticker may be treated like a physical object or a token, which may be used in one place at a time by a single user. The user may choose to use the peeled off sticker in various ways. For example, the user may affix it to another message card to send it to another receiver. He may store it for later use or in a collection, but generally he may not copy or multiply it. The peeled off sticker may include some unique content that makes it desirable to have. For example, it may have a unique image of a celebrity, it may be from an important source like a famous politician, author, or other celebrity, and the like.

In various embodiments, stickers may be associated with credit points, which may be used to buy, sell, gift, or conduct other economy-oriented transactions in a manner similar to how money is used for goods and services in a marketplace. For example, a receiver of a sticker may pay a number of points to extract certain information or behavior from the sticker, such as show a video clip earlier than scheduled.

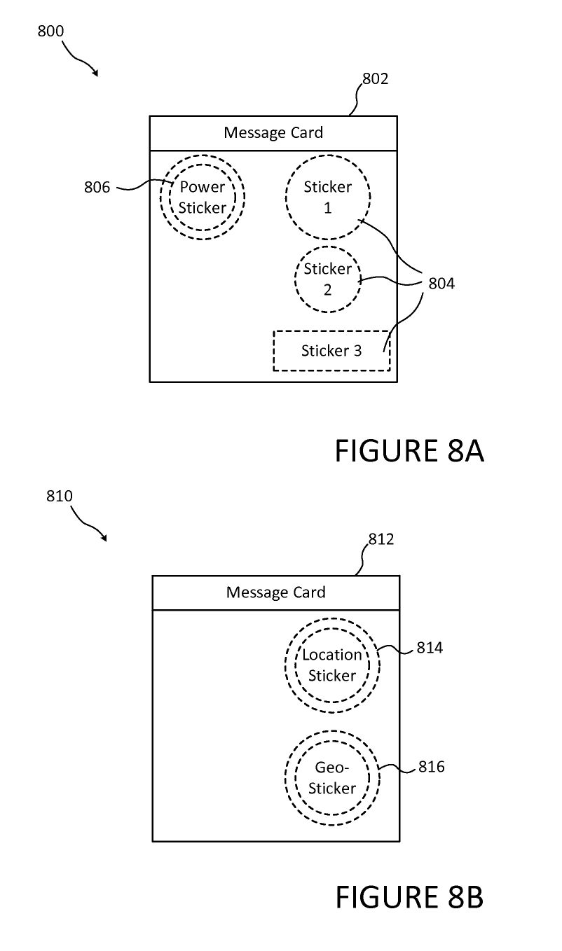

FIG. 8A shows an example message card having a mix of regular and power stickers deployed thereon. In various embodiments, message card 800 includes a display area 802, software stickers 804, and software power stickers 806.

In various embodiments, a power sticker is generally an active or dynamic sticker with relatively broader scope of use than non-power regular software stickers. An active sticker can perform an action, dynamically acquire new information, or actively react to an input, in contrast to a passive sticker, which only contains static or fixed information. Even a sticker, which includes a video clip, only includes fixed information in that the video clip does not change over the lifetime of the sticker. Some of the software stickers, such as geo caching stickers, described above are power stickers.

In various embodiments, power stickers and passive stickers may be applied to the same message card. The power stickers generally have the same characteristics as passive stickers but have added capabilities as noted in their respective descriptions. Those skilled in the art will appreciate that the stickers may classified based on other parameters such as content type, behavior, use, source, size, and the like. For example, content type-based categories may include text-based stickers and media stickers, while use-based categories may include location stickers and gaming stickers. Furthermore, one sticker type may fit into multiple categories depending on the categorization parameter used. Some power stickers are further described below.

A Location sticker is enabled via GPS or cell tower detection of a particular location. For example, if the user goes to a particular store, or a particular friend's house, then the sticker is uncovered to reveal some relevant information such as special coupons or an old school picture, respectively. A location sticker may also announce to all or predetermined recipients the location of the holder of the sticker.

A “Where Are You” sticker may implicitly put a query to the recipient regarding his/her location and may be location-enabled via GPS, WiFi, cell tower, or other techniques for detection of a particular recipient's location. For example, a recipient of the Where Are You sticker may tap and hold on the sticker to indicate that he/she wants to provide his/her location as an answer to the query from the sender. The result of the tapping on the sticker may automatically generate a new message card with a location that is sent back to the sender or may affix a new sticker to the original card and send it back. Tapping on the new sticker may reveal the recipient's location.

A “Call Me” sticker may be used to ask a recipient to call the sender of the sticker. For example, if the recipient taps on this sticker, the sticker may automatically cause a phone application to be launched on the recipient's computing device, such as a smartphone, and make a call to the sender.

A “Hastag” sticker may be used to allow public post and/or discovery of a message card. For example, applying the Hashtag sticker may cause cross posts of the message card to a public, discoverable forum such as Twitter or an internal, application-specific forum for discovering publically shared single messages or entire conversation threads.

An “I'm Here” sticker may declare and/or send the location of the person who affixed the sticker. When the recipient taps or holds the sticker, a map may appear or a navigation application may be launched to show the user's physical location.

An Autoshare sticker may be used to automatically forwards the messagee card to which it is affixed to all of the user's contacts.

A Callback sticker may allow the affixer to revoke the card to which it was affixed. All original recipients of the message card will no longer be able to access the card.

A Lock sticker may allow the affixer to hide the contents of the affixed card unless a security check (for example, a passcode, facial recognition, bio-identification, or proximity to a geographical location) is validated successfully.

A Paparazzi sticker, when affixed to a card, may require the recipient to hold down the sticker in order to see the original card content. At the same time, a photo or video may be taken of the recipient's facial expression and will be sent to the affixer of the sticker.

A Flashbang sticker may cause the recipient's camera flash to be activated.

A Shake sticker is useable to transfer a haptic experience. When a sender sends a shake sticker, the recipient experiences a vibration through his smartphone upon activating the sticker, for example by touching it or by opening the message card to which the sticker is attached. A shake sticker causes a code to be executed to activate the vibration function of the smartphone.

A Reveal sticker may be used to show other user's stickers. A message card may be sent to multiple recipients and be responded to by multiple recipients. In group messaging, the message may be sent via BCC (Blind-Carbon Copy), so that not all the recipients know the reactions and stickers of the other recipients. This is in contrast to group messaging. In this case the Reveal sticker would show off what everyone else replied with. A recipient of the card may post a Reveal sticker to reveal everyone else's stickers in response to or otherwise associated with the posted card.

A Shield sticker may be used to shield or defend a user against other user's power stickers, such as the reveal sticker.

A Contact Request sticker may be used to launch a phone or email software application on the computing device of the receiver and prepare a contact form, such as an email, populated with the sender's information, such as sender's address, name, subject, and the like.

A Reply sticker is a meta sticker for creating threads of message cards. In some embodiments, finger tapping the Reply sticker may send another message card all under the topmost or first message card to create a chain of message cards. Most actions taken on the first card applies to all subsequent cards. For example, saving the topmost card will save the message chain or thread. Reply stickers may allow recipients to reply with future cards by tapping on these stickers. Tapping may associate the cards with a Reply sticker as belonging to a thread. The thread may then be treated as a single entity, and can be saved, deleted, forwarded etc. as if it were a single card. So, Reply sticker may be used to aggregate message cards into a single thread entity.

A Graffiti sticker enables the sender to draw free-hand on the message card and its contents. It may be activated when pressed or tapped by the user.

A Cross Post sticker enables tapping on the sticker to take or redirect the user to a social media post. For example, if a message is posted on Facebook, then tapping on the Cross Post sticker takes the user to the post on Facebook.

A Walkie-talkie sticker may be held down (touched steadily) to call the sender of the message card, for example, using a real-time audio or multimedia channel.

A Geo-caching sticker's contents may stay hidden until the holder of the sticker goes to a certain location as detected by GPS.

A Hologram sticker may change as a result of the movement of the computing device as detected by accelerometer.

A Challenge sticker may be used to challenge another user to gain points or win a predefined competition such as to place the most stickers on a message card.

A Bounty sticker may be used to transfer credit points from one user to another, for example, as a gift, coupon, a promotion, and the like.

A Vampire sticker “sucks the life” out of a sender's message card, that is, reduce its visibility or usability, for example, by making the contents of the card less visible by burring them, or have chunks of data on the card disappear, until some predefined event occurs. The predefined event may be a reply to the sender's card, taking some action, executing a software application, and the like.

A One-up sticker operates to replace the contents of the sender's message card with other content. For example, an image may be replaced by another image on the message card.

A Props sticker gives the message card sender some form of advantage in the form of points, reward, recognition, and the like.

A Fog sticker provides visual effects for the contents of the message card. Specifically, it visually covers the contents of the card with fog-like effect to blur the contents. To see the contents, the user may mimic “wiping off” the fog with touch or “blow it away” using the microphone.

A Bomb “blows up” or electronically permanently damages the sender's message card and makes it unavailable. A Super Bomb may do the same thing to all copies of the same card sent to other users.

A Narcissist sticker may disable message card stack navigation, search, filtering, and/or other operations by locking the card stack until an event happens such as the receiver records a statement about the sender. For example, the receiver may need to record “the sender is my hero” and send it back to the sender before the card stack is unlocked.

A Timer sticker may be used to play a time-based game to gain credit points. It may also be used for timing events or time remaining to an event. For example, in a game arrangement, the Timer sticker may be applied by the card receiver and sent back to the card sender to hide the notification for this sticker and not place the message card in the card deck. A recorded sound (pre-recorded or recorded by message card receiver) associated with the sticker is played at a faster and faster pace until the sender can find the card and tap to disable it. If the sender is unable to disable it before the time expires a buzzer goes off and the card sender cedes points to the sticker's sender (the message card's initial receiver). Otherwise the sender gets points from the receiver.

A Hot potato sticker may be used in a “pass the sticker” game in which the Hot potato sticker consumes and takes away points from the receiver of the message card having this sticker, until the receiver finds the sticker, peels it off the card and passes it to someone else on a message card. The last person to receive the sticker loses the game.

As noted earlier, various types of software stickers may be classified differently depending on the categorization parameter chosen. The following are some additional categories and/or types of stickers which may overlap with some of the sticker types described above.

Dynamic Stickers allow quick replies and acknowledgement, which indicate that the receiver liked the sender's comments or card contents. It may also include some comments.

Text Reactions/Response stickers are quick access responses/reactions to received content. Instead of typing text responses to content received on a message card, the receiver may append a predefined Response sticker with a tap on the touch screen to select the appropriate pre defined sticker. The Text Response is not monotonic (that is, a single response type such as a “like” or “favorite” sticker.) Rather, it may have a range of qualifiers and emotions as expressed through text. The user may predefine his own set of Text Response stickers to be ready for a range of incoming message card contents. This is a useful and novel technique for responding to a message because it is used to remark on rich content of message cards as a quick response. Instead of typing comments, predefined stickers help users respond quickly using stickers that have text pre recorded on them. In some languages, text may be phoneticized using English characters but made into specific words, sounds and expressions in these languages.

Media Stickers generally include text or emoticons and may also have preset voice or customized voice recordings by the user. In various embodiments, a user can upload photos showing facial expressions and other messages as a sticker. The user or responder to a message may upload a short video clip as a reaction or response to a received message card. The Media stickers may provide a useful technique for responding with rich content over a low bandwidth communication channel, such as a cell phone. The user may also attach a hotlink (for example, webpage or app link) into sticker to provide a rich response to rich content. The user may also attach a GIF picture or a sound clip as a sticker or as part of a sticker. In some embodiments, the sticker may include or itself be a shortcut to another message card that is connected with and becomes part of a communication thread of the original message card. In various embodiments, packs of stickers may be picked, prioritized, shown, and/or hidden based on gender, geography, language, or other characteristics of party to communication.

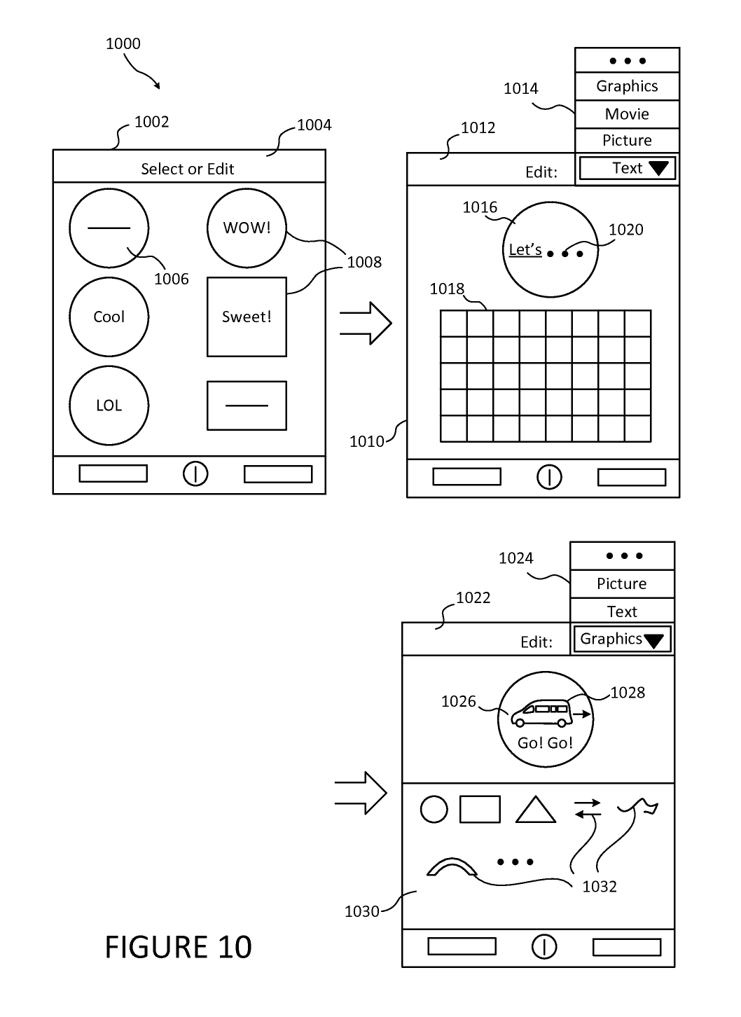

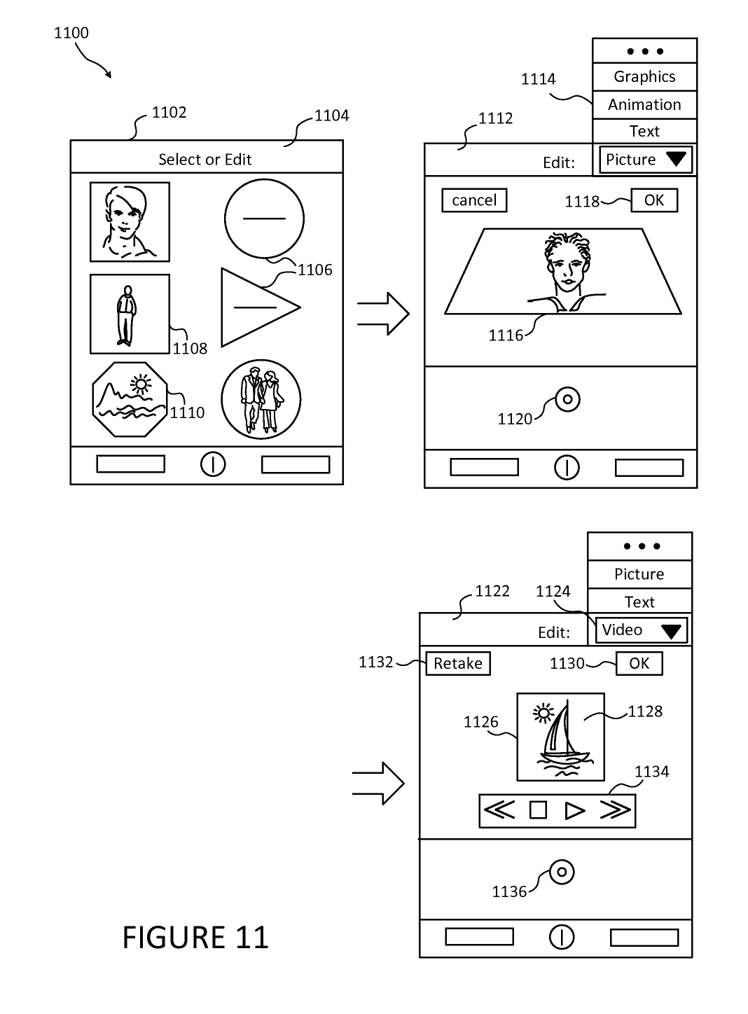

Blanks and Template stickers may be used to construct custom stickers, as further described with respect to FIGS. 10 and 11. Blank and Template sticker packs or individual stickers may be designed where the customer can type the text, include pictures, sounds, and video clips connoting expressions, inside jokes, reactions and responses. Once filled out or once affixed to a card, the blank sticker is “used up” and turns into the specific sticker that can be subsequently used by the customer—the blank sticker is no longer modifiable. By turning blank stickers into custom stickers, sticker customization is enabled. Once generated, a customized sticker pack may be upgraded to high quality, high fidelity, or feature designs (gold, metallic, holographic, etc.) stickers.

On-demand composition of animating stickers allows users to combine any number of stickers by selecting more than one sticker from the various packs to compose and animating sequence of stickers (for example, a sequence of hand gestures indicating the phrase “pop it, lock it, drop it”) as a custom made animating sticker, as further described above with respect to FIG. 5C. Using this novel technique allows users to express themselves with various emoticons or text based stickers. This configuration allows people to compose more complex thoughts as an animating sequence of stickers in the sequence specified by the user. These stickers can transition from one to another in sequence based on time or rotational movement of the smartphone. For example, the user may rotate the phone on some predefined axis to see animation sequence of stickers. This animation may also be triggered automatically without user action, or intentionally by tapping and/or holding the sticker.

Holographic Stickers may be created by leveraging the accelerometers on smartphones to detect its rotation and the rotation axis. Using these physical sensor devices, the appearance and other visual characteristics of a sticker may be altered. For example, by rotating the smartphone about its long axis, colors may be shifted, while rotating about its short axis focus may be changed. Similarly, the user can alternate the sticker's appearance by adjusting the light source of the rendering, via physical movement of the smartphone, to display a metallic or holographic image, or change the focus in the sticker (for example, shifting focus to foreground of the sticker image or its background). This results in a visually superior sticker that is of a higher quality and perceived value as compared to regular stickers. Holographic stickers were further described above with respect to FIG. 5E.

Peeling Custom stickers, created using Blank and Template stickers described above, allows recipients to use them later. The number of times these stickers can be used may be configured to be limited or unlimited once peeled. This way, new customized stickers are made available to all participants. Optionally, the information on the creator and/or the origin of a custom sticker pack may be withheld. Alternatively, an author/creator of a custom sticker may not withhold his identity so other users can discover new stickers from the same author to use for their own message cards. Peeling stickers was further described above with respect to FIG. 7.

Haptic Response stickers, described above with respect to FIG. 8A, may reveal content of a message card to which they are affixed when touched in certain ways. For example, a user may scratch the sticker to reveal the true contents underneath. As the user touches the sticker's area of display on the computing device the sticker and goes back and forth in a scratching action, a haptic response by the phone may be provided to further provide the feeling of a physical scratching motion. This novel technique conceals the primary content until the user interacts with the sticker in this particular way.

Gifting through stickers may be realized when a user attaches a gift, in the form of credit points or coupon for physical items, to a message card as a sticker. The user can visually detect the gift stickers via some indicator such as a particular symbol, color, shape or other characteristic associated with the gift sticker. Such gift stickers may also be concealed from the recipient until he interacts with the sticker, for example, by shaking the phone or scratching the sticker. Once scratched, the gift may become a message card containing more data/content and better fidelity. Also, stickers may be used to claim a coupon, gift, offer, and other similar benefits. For instance, a retail entity may send a card offering a discount on some product. Affixing a Buy sticker may allow the purchase of the product, redeem the discount coupon, and the like.

Most frequently used and/or trending stickers or sticker packs may be packaged as a special or custom pack for sale to users. Such packs may be used as gifts, incentives, promotions, and the like.

FIG. 8B shows an example message card with multiple power stickers. In various embodiments, message card 810 includes display area 812, and multiple power stickers 814 and 816.

In various embodiments, the power stickers may be mixed with other types of stickers, as described above. For example, a Location sticker and a Geo sticker may be affixed to the message card, along with other types of stickers. Each sticker performs its own functions while some stickers may also interact or perform different parts of the same function or operation. A Location sticker may reveal what is under it when the user goes to a particular location. The Geo sticker may have additional information revealed based on the same or other locations and together these information may fulfill part of a geo caching game.

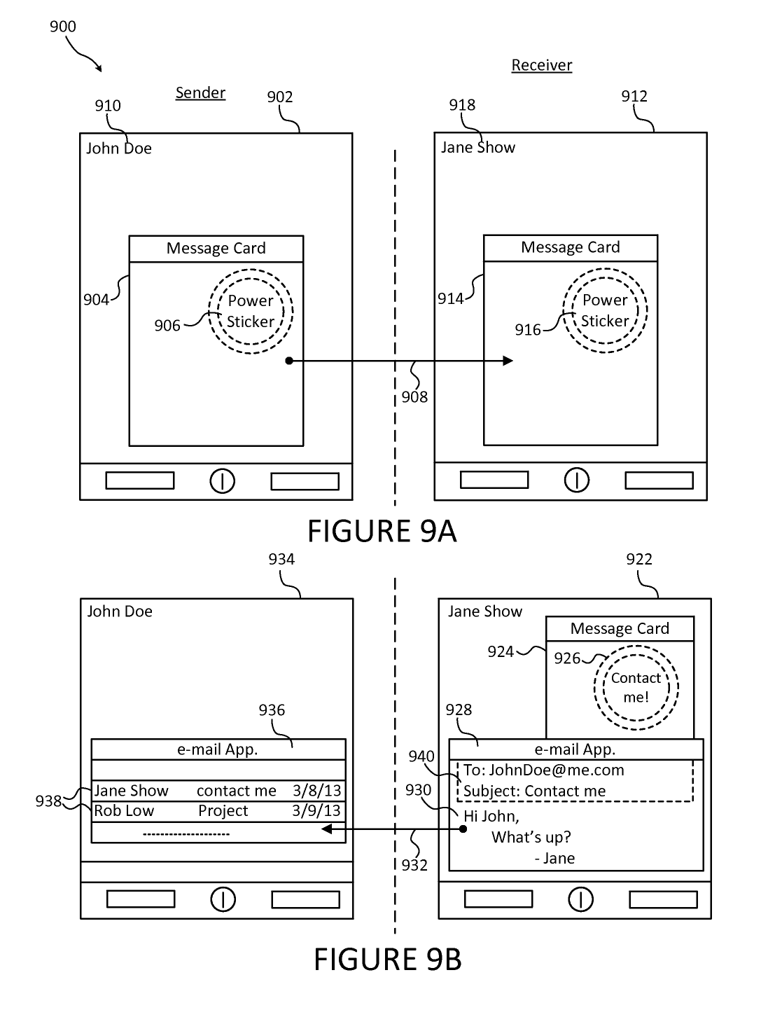

FIG. 9A shows an example communication session between a sender and a receiver using message cards and power stickers. In various embodiments, communication session 900 between a sender and a receiver includes a transmitting computing device 902 associated with a first user 910 and a receiving computing device 912 associated with a second user 918. A message card 904 having a power sticker 906 is sent to the receiving computing device, as indicated by arrow 908, becoming received message card 914 with power sticker 916.

In various embodiments, for some power stickers such as Shake and Contact stickers, upon the receipt of the power sticker 916 by the receiving computing device 912 some action may be taken on the receiving computing device or associated with it. For example, if a Contact sticker is transmitted then an email application may be launched, filled with the recipient's (sender's) information to initiate the contact, as further described below with FIG. 9B.

FIG. 9B shows the example communication session of FIG. 9A where the power sticker activates a different software application. In various embodiments, receiving computing device 922, corresponding to the receiving computing device 912 of FIG. 9A, includes received message card 924 with Contact power sticker 926, which has caused email application 928 to be launched. The email application 928 includes header 940 and body 930. The email message so constructed is intended for transmission back to the transmitting computing device 934, corresponding to transmitting computing device 902, as indicated by arrow 932. The second user 918, associated with the receiving computing device 922, may enter a message in the body of the email prior to transmitting it back to the first user 910 associated with transmitting computing device 934.

On receipt of the contact email, as originally requested by the Contact power sticker, the first user 910 may review the email via his email application 936 as a new email 938.

As noted above, a Contact power sticker is one type of power sticker which causes a communication software application, such as an email application to be activated. Other power stickers behave differently as appropriate for the sticker type.

FIG. 10 shows an example computing device on which software stickers with text and graphics contents may be created. In various embodiments, editing system 1000 includes computing device 1002, a sticker editing software module 1004 configured to create and/or edit stickers 1006 and 1008. In edit mode, on computing device 1010, corresponding to computing device 1002, sticker editing software module 1012, corresponding with sticker editing software module 1004, presents a menu 1014 of types of editing the user intends to do to construct sticker 1016 having contents 1020, and keyboard 1018 for text-based editing. For graphics editing, on computing device 1022 corresponding to computing device 1002, graphical content 1026 of sticker 1028 is added using a graphical component toolbox 1030 with various graphical components and tools 1032.

In various embodiments, to edit the sticker to add textual content option Text is selected from the edit type menu 1014. The editing software module presents the user with a keyboard 1018 to add text to the sticker 1016. Those skilled in the art will appreciate that text editing may include many tools for coloring the text, the background, selecting fonts, adding shading, and various other effects, that are not shown in FIG. 10 to maintain simplicity and clarity. Also, the users may obtain certain shapes, textures, paintbrushes, effects, images, and the like via a free or paid external catalog.

For each type of editing that the user selects from the edit type menu an appropriate interface is presented to enable the user to add the type content selected. For example, to add a picture, the user may be presented with a navigation dialog box to select a picture file from a file system of the computing device. Additionally, the user may be presented with a camera interface to take a picture of himself or other subjects and add to the sticker being edited and/or created, as further described below with respect to FIG. 11.

In various embodiments, to add graphical content to the sticker being created/edited, various components from toolbox 1030 may be combined to create a graphical work. For example, to draw a car, the user may use a rectangle graphical component as the body, circles as the wheels, and free-hand curves for showing roads or back ground buildings. Those skilled in the art will appreciate that the graphical toolbox may include many editing facilities not shown in FIG. 10. For example, a color palette, shading tools, sizing tools, and the like may be part of the toolbox.

In various embodiments, the sticker thus created and customized may become fixed and unchangeable, while in other embodiments, the custom sticker may be editable according to edit permission settings associated with the custom sticker. For example, the permission settings on a sticker may only allow the original author to edit it. The permission settings may also be transferrable, so that a user that purchases or otherwise receives control of the sticker may also gain permission to edit it.

Those skilled in the art will appreciate that many other user interfaces for creating/editing stickers may be used without departing from the spirit of the present disclosure. For example, context sensitive dialog boxes and/or menus may be used to edit a selected sticker in place rather than, or in addition to, using a stand-alone edit software application.

FIG. 11 shows an example computing device on which software stickers with pictorial and video contents may be created. In various embodiments, editing system 1100 includes computing device 1102, a sticker editing software module 1104 configured to create and/or edit stickers 1106, 1108, and 1110. In edit mode, on computing device 1112, corresponding to computing device 1102, sticker editing software module 1112, corresponding with sticker editing software module 1104, presents a menu 1114 of types of editing the user intends to do to construct sticker 1116. Camera control button 1120 used to control a camera embedded in the computing device 1112 may be used to acquire a new picture to include in the sticker being edited, while edit control button 1118 may be used to accept the edits. For video editing selected from edit type menu 1124, on computing device 1122 corresponding to computing device 1122, a video creation and editing interface 1134 may be presented to the user to create video content 1128 for sticker 1126. Other video control buttons including OK button 1130, Retake button 1132, and record button 1136 may also be provided.

In various embodiments, one or more pictures may be added to a custom sticker. The picture may be preexisting, downloaded from the Internet, taken by the camera embedded in the computing device, or otherwise obtained. For example, for a quick reply to a message card, the user/receiver may take a picture of himself with an appropriate expression, such as surprise or happiness, insert it into the custom sticker, and send it back to the sender of the message card. The reply may be done in a matter of seconds of receiving the message card with a custom sticker having rich content.

In various embodiments, one or more video clips may be added to a custom sticker. The video may be preexisting, downloaded from the Internet, taken by the camera embedded in the computing device, or otherwise obtained. For example, for a quick reply to a message card, the user/receiver may take a video clip of himself with an appropriate message, expression, or other content, insert it into the custom sticker, and send it back to the sender of the message card. The reply may be done in a matter of seconds of receiving the message card with a custom sticker having rich content.

It will be understood that each step in the described processes and techniques can be implemented by computer program instructions. These program instructions may be provided to a processor to produce a machine, such that the instructions, which execute on the processor, create means for implementing the actions specified in the process. The computer program instructions may be executed by a processor to cause a series of operational steps to be performed by the processor to produce a computer implemented process such that the instructions, which execute on the processor to provide steps for implementing the actions specified in the process. The computer program instructions may also cause at least some of the operational steps described to be performed in parallel. Moreover, some of the steps may also be performed across more than one processor, such as might arise in a multi-processor computer system. In addition, one or more steps or combinations of steps in the described processes may also be performed concurrently with other steps, or even in a different sequence than illustrated without departing from the scope or spirit of the disclosure.

It will also be understood that each step of the described processes or combinations thereof, can be implemented by special purpose hardware based systems, which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A message-based communication system comprising:
a message card processing software module that when executed on a computing device causes the computing device to create a message card, wherein the message card is a software object configured to contain executable code and information content, and is further configured to be sent to a receiving computing device as a messaging unit.

2. The system of claim 1, further comprising a message card editing software module.

3. The system of claim 1, further comprising a software sticker editing software module.

4. The system of claim 1, wherein the computing device is a smartphone.

5. The system of claim 1, wherein the message card processing software is used to transmit the message card as a single-use messaging unit.

6. The system of claim 1, wherein a content of the message card is at least one of text, picture, sound, graphics, video, and animation.

7. The system of claim 1, wherein a software sticker associated with the message card is further associated with executable code that causes the receiving computing device to take a predetermined action when the software sticker is received at the receiving computing device.

8. The system of claim 1, wherein a software sticker associated with the message card is configured to detect a scratching motion on a touch-screen of the computing device and is further configured to expose data visually hidden under the software sticker.

9. The system of claim 1, wherein the message card is configured to be associated with other message cards to form a message card stack.

10. The system of claim 9, wherein the message card stack is configured to be filtered based on at least one of sender, content type, and date range.

11. A message-based communication method, the method comprising:
using a message card processing software module to create a message card for being sent to a receiving computing device, wherein the message card is a software object configured to include executable code and data;
inserting multi-media data into the message card; and
sending the message card to the receiving computing device.

12. The method of claim 11, further comprising visually associating a software sticker with the message card.

13. The method of claim 11, further comprising taking a picture or a video clip using a camera of the computing device and including the picture or the video clip on the message card.

14. The method of claim 11, wherein using a message card processing software module comprises including predetermined data on the message card.

15. The method of claim 11, wherein inserting multimedia data comprises inserting at least one of text, picture, sound, graphics, video, and animation into the message card.

16. The method of claim 11, further comprising filtering a stack of message cards based on at least one of a sender, content type, and date range.

17. A message-based communication method, the method comprising:
generating a message card configured to include executable code and multimedia data;
obtaining multi-media data;
inserting the multi-media data into the message card; and
sending the message card to a receiving computing device.

18. The method of claim 17, further comprising affixing a software sticker to the message card.

19. The system of claim 18, wherein the software sticker is configured to detect and response to external input.

20. The system of claim 17, further comprising using pre-existing message card templates to generate the message card.
